(19) United States
(12) Patent Application Publication
(10) Pub. No.: US 2015/0172666 A1
(43) Pub. Date: Jun. 18, 2015

(54) METHOD AND APPARATUS FOR SAMPLE ADAPTIVE OFFSET CODING WITH SEPARATE SIGN AND MAG -NITUDE

(71) Applicant: MEDIATEK INC., Hsin-Chu, TW (TW)

(72) Inventors: Chih-Ming Fu, Hsinchu City (TW); Yu-Wen Huang, Taipei (TW); Shaw-Min Lei, Hsinchu County (TW)

(73) Assignee: MEDIATEK INC., Hsinchu (TW)

(21) Appl. No.: 14/388,818

(22) PCT Filed: Feb. 26, 2013
(86) PCT No.: PCT/CN2013/071882

§ 371 Date: Sep. 29, 2014

Related U.S. Application Data
(60) Provisional application No. 61/624,794, filed on Apr. 16, 2012.

(51) Int. Cl. H04N 19/132; H04N 19/169; H04N 19/196; H04N 19/167; H04N 19/17

(52) U.S. Cl. CPC H04N 19/132; H04N 19/167; H04N 19/17; H04N 19/196; H04N 19/1887

(57) ABSTRACT

A method and apparatus for encoding or decoding SAO (sample adaptive offset) parameters in a video encoder or decoder are disclosed. Embodiments according to the present invention encode or decode signs and magnitudes of SAO offset values separately for a region using band offset, where the signs are coded using bypass mode coding or fixed length coding. In one embodiment, the magnitudes of the SAO offset values for a region are grouped and coded together. If the SAO type is not band offset, the signs of the SAO offset values are omitted from the compressed data associated with the region. In another embodiment, the magnitude of the SAO offset value for band offset is checked to determine whether it is zero. If the magnitude of the SAO offset value is zero, there is no need to incorporate the sign of the SAO offset value in the compressed data.

### CROSS REFERENCE TO RELATED APPLICATIONS

The present invention claims priority to U.S. Provisional Patent Application, No. 61/624,794, filed on Apr. 16, 2012, entitled “SAO offset coding with separate sign and magnitude”. The U.S. Provisional Patent Application is hereby incorporated by reference in its entirety.

### BACKGROUND OF THE INVENTION

1. Field of the Invention

The present invention relates to video coding. In particular, the present invention relates to video coding techniques associated with encoding and decoding of sample adaptive offset information.

2. Description of the Related Art

Motion estimation is an effective inter-frame coding technique to exploit temporal redundancy in video sequences. Motion-compensated inter-frame coding has been widely used in various international video coding standards. The motion estimation adopted in various coding standards is often a block-based technique, where motion information such as coding mode and motion vector is determined for each macroblock or similar block configuration. In addition, intra-coding is also adaptively applied, where the picture is processed without reference to any other picture. The inter-predicted or intra-predicted residues are usually further processed by transformation, quantization, and entropy coding to generate a compressed video bitstream. During the encoding process, coding artifacts are introduced, particularly in the quantization process. In order to alleviate the coding artifacts, additional processing can be applied to reconstructed video to enhance picture quality in newer coding systems. The additional processing is often configured in an in-loop operation so that the encoder and the decoder may derive the same reference pictures.

FIG. 1 illustrates an exemplary adaptive inter/intra video coding system incorporating in-loop filtering process. For inter-prediction, Motion Estimation (ME)/Motion Compensation (MC) 112 is used to provide prediction data based on video data from other picture or pictures. Switch 114 selects Intra Prediction 110 or inter-prediction data from ME/MC 112 and the selected prediction data is supplied to Adder 116 to form prediction errors, also called prediction residues or residues. The prediction error is then processed by Transformation (T) 118 followed by Quantization (Q) 120. The transformed and quantized residues are then coded by Entropy Encoder 122 to form a video bitstream corresponding to the compressed video data. The bitstream associated with the transform coefficients is then packed with side information such as motion, mode, and other information associated with the image unit. The side information may also be processed by entropy coding to reduce required bandwidth. Accordingly, the side information data is also provided to Entropy Encoder 122 as shown in FIG. 1 (the motion/mode paths to Entropy Encoder 122 are not shown). When the inter-prediction mode is used, a previously reconstructed reference picture or pictures have to be used to form prediction residues. Therefore, a reconstruction loop is used to generate reconstructed pictures at the encoder end. Consequently, the transformed and quantized residues are processed by Inverse Quantization (IQ) 124 and Inverse Transformation (IT) 126 to recover the processed residues. The processed residues are then added back to prediction data 136 by Reconstruction (REC) 128 to reconstruct the video data. The reconstructed video data may be stored in Reference Picture Buffer 134 and be used for prediction of other frames.

As shown in FIG. 1, incoming video data undergoes a series of processing in the encoding system. The reconstructed video data from REC 128 may be subject to various impairments due to the series of processing. Accordingly, various loop processing is applied to the reconstructed video data before the reconstructed video data is used as prediction data in order to improve video quality. In the High Efficiency Video Coding (HEVC) standard being developed, Deblocking Filter (DF) 130, Sample Adaptive Offset (SAO) 131 and Adaptive Loop Filter (ALF) 132 have been developed to enhance picture quality. The Deblocking Filter (DF) 130 is applied to boundary pixels and the DF processing is dependent on the underlying pixel data and coding information associated with the corresponding blocks. There is no DF-specific side information needs to be incorporated in the video bitstream. On the other hand, the SAO and ALF processing are adaptive, where filter information such as filter parameters and filter type may be dynamically changed according to the underlying video data. Therefore, filter information associated with SAO and ALF is incorporated in the video bitstream so that a decoder can properly recover the required information. Furthermore, filter information from SAO and ALF is provided to Entropy Encoder 122 for incorporation into the bitstream. In FIG. 1, DF 130 is applied to the reconstructed video first; SAO 131 is then applied to DF-processed video; and ALF 132 is applied to SAO-processed video. However, the processing order among DF, SAO and ALF may be re-arranged. In the High Efficiency Video Coding (HEVC) video standard being developed, the loop filtering process includes DF and SAO.

In HM-6.0, a picture may be divided into multiple regions using a quad-tree partition method. Also, a picture can be divided into largest coding units (LCUs), where each LCU may be further partitioned into coding units. Accordingly, an LCU is also referred to as a coding tree block (CTB). Each region can select one SAO type among five SAO types including one Band Offset (BO) type and four Edge Offset (EO) types. Each region may also select no SAO processing (i.e., OFF). For each to-be-processed (also called to-be-filtered) pixel, BO uses the pixel intensity of the pixel to classify the pixel into a band. The pixel intensity range is equally divided into 32 bands according to HM-6.0, as shown in FIG. 2. After pixel classification, one offset value is derived for the pixels of each band. In EO, pixel classification is first done to classify pixels into different groups (also called categories or classes). The pixel classification for each pixel is based on a 3×3 window, as shown in FIG. 3 where four configurations corresponding to 0°, 90°, 135°, and 45° are used for classification. Upon classification of all pixels in a picture or a region, one offset value is derived and transmitted for each group of pixels. In HM-6.0, SAO is applied to luma and chroma components, and the luma and chroma components are independently processed. Similarly, one offset value is derived for all pixels of each category except for category 4 of EO, where Category 4 is forced to use zero offset. Table 1 below lists the EO pixel classification derivation, where “C” denotes the pixel to be classified.

TABLE 1

| Category | Condition |
|---|---|
| 0 | C < two neighbors |
| 1 | C < one neighbor && C == one neighbor |
| 2 | C > one neighbor && C == one neighbor |
| 3 | C > two neighbors |
| 4 | None of the above |

The SAO parameters for a region have to be incorporated in the bitstream so that a decoder can recover the necessary information to apply SAO processing properly at the decoder side. The SAO parameters consist of one SAO type and multiple offset values. Table 2 shows the syntax table of SAO parameters associated with a region according to HM-6.0, where sao_offset is the SAO offset value which is a signed value for BO and unsigned value for EO. In HM-6.0, there are 4 offset values in each region (or LCU) as shown in Table 2 for a selected sao_type_idx except when sao_type_idx is OFF. For BO, four consecutive bands are grouped together, where the starting band is indicated by sao_band_position. An exemplary 4-band group 200 is illustrated in FIG. 2. The first band position of this 4-band group is indicated by arrow 210. For the EO type, there are four offset values associated with the four classification categories (i.e., categories 0 through 3 in Table 1). Accordingly, there are always four offset values incorporated in the SAO syntax for each region using either the BO type or the EO type. The SAO parameters have to be transmitted for each region so that a decoder can recover the needed SAO parameters. In order to reduce the associated bit rate, entropy coding, such as context-adaptive binary arithmetic coding (CABAC) or variable length coding (VLC), is usually applied to the SAO parameters. The complexity may be high. Therefore, it is desirable to reduce the coding complexity for SAO parameter coding.

TABLE 2

Descriptor

sao_offset_cabac( rx, ry, cIdx ) {

| | |
|---|---|
| sao_type_idx[ cIdx ][ rx ][ ry ] | ae(v) |
| if( sao_type_idx[ cIdx ][ rx ][ ry ] = =5 ) | |

| | |
|---|---|
| sao_band_position[ cIdx ][ rx ][ ry ] | ae(v) |

if( sao_type_idx[ cIdx ][ rx ][ ry ] != 0 )

for( i = 0; i < 4; i++ )

| | |
|---|---|
| sao_offset[ cIdx ][ rx][ ry ][ i ] | ae(v) |

}

### BRIEF SUMMARY OF THE INVENTION

A method and apparatus for encoding or decoding SAO (sample adaptive offset) parameters in a video encoder or decoder are disclosed. Embodiments according to the present invention encode or decode signs and magnitudes of SAO parameters separately. Furthermore, the signs of the SAO offset values are coded using bypass mode coding or fixed length coding. According to one embodiment of the present invention, the magnitudes of the SAO offset values for a region are grouped and coded together. If the SAO type corresponds to band offset, the signs of the SAO offset values for a region are grouped and coded together using bypass mode coding or fixed length coding. If the SAO type is not band offset, the signs of the SAO offset values are omitted from the compressed data associated with the region. In another embodiment, the magnitude of the SAO offset value is checked to determine whether it is zero for the band offset type. If the magnitude of an SAO offset value is zero, there is no need to incorporate the sign of the SAO offset value in the compressed data. The magnitude part of the SAO offset values can be coded using entropy coding, where the entropy coding may correspond to context adaptive binary arithmetic coding or variable length coding. If the SAO type corresponds to edge offset, the magnitude part of the SAO offset values is coded using entropy coding as well. When variable length coding is used to compress the magnitude part of the SAO offset values, at least a portion of codewords for the magnitude part can be coded using unary coding, truncated unary coding, or exponential-Golomb coding. When context adaptive binary arithmetic coding is used to compress the magnitude part of the SAO offset values, at least a portion of codewords for the magnitude part can be coded using unary binarization, truncated unary binarization, or exponential-Golomb binarization.

### BRIEF DESCRIPTION OF DRAWINGS

FIG. 1 illustrates an exemplary video coding system using Inter/Intra prediction, where loop filter processing including deblocking filter (DF), sample adaptive offset (SAO) and adaptive loop filter (ALF) is incorporated.

FIG. 2 illustrates an example of band offset (BO) by equally dividing the pixel intensity range into 32 bands.

FIG. 3 illustrates edge offset (EO) pixel classification based on a 3×3 window, with four configurations corresponding to 0°, 90°, 135°, and 45°.

FIG. 4A illustrates an example of the SAO offset values associated with a region.

FIG. 4B illustrates an example that the magnitudes of the SAO offset values associated with a region using the band offset type are grouped together for entropy coding.

FIG. 4C illustrates an example that the signs of the SAO offset values associated with a region processed using the band offset type are grouped together for bypass mode coding or fixed length coding.

FIG. 4D illustrates an example that the sign and magnitude of each SAO offset value associated with a region using the band offset type are coded separately.

FIG. 5A illustrates an example that the magnitudes of the SAO offset values associated with a region using the band offset type are grouped together for entropy coding, where the magnitude is checked to determine whether the magnitude is zero.

FIG. 5B illustrates an example where the signs of the SAO offset values associated with a region processed using the band offset type are grouped together, where the sign of an offset value is omitted from the compressed data if the corresponding magnitude is zero.

FIG. 6 illustrates an exemplary flowchart of SAO offset value encoding for a video encoder incorporating an embodiment of the present invention.

FIG. 7 illustrates an exemplary flowchart of SAO offset value decoding for a video decoder incorporating an embodiment of the present invention.

FIG. 8 illustrates an exemplary SAO syntax design incorporating an embodiment of the present invention.

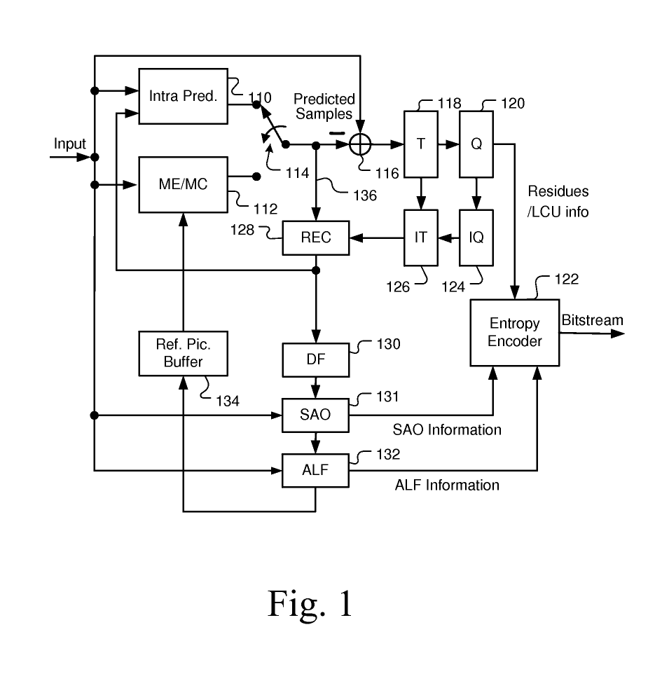

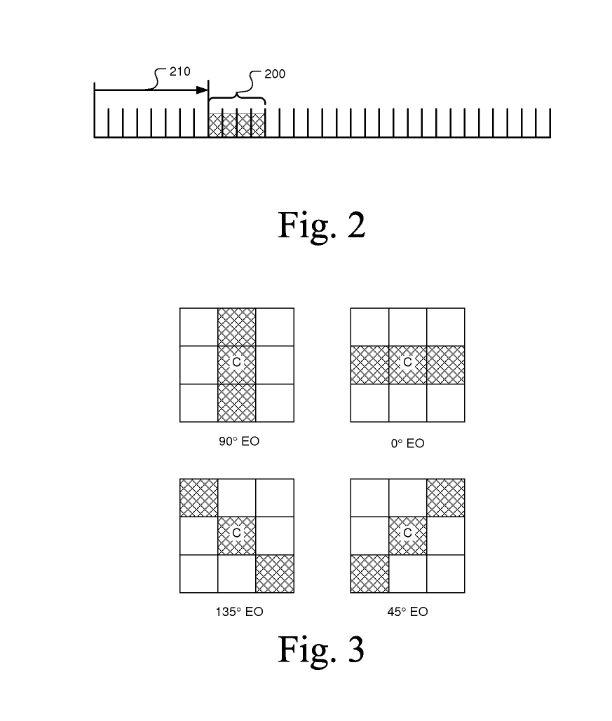

### DETAILED DESCRIPTION OF THE INVENTION

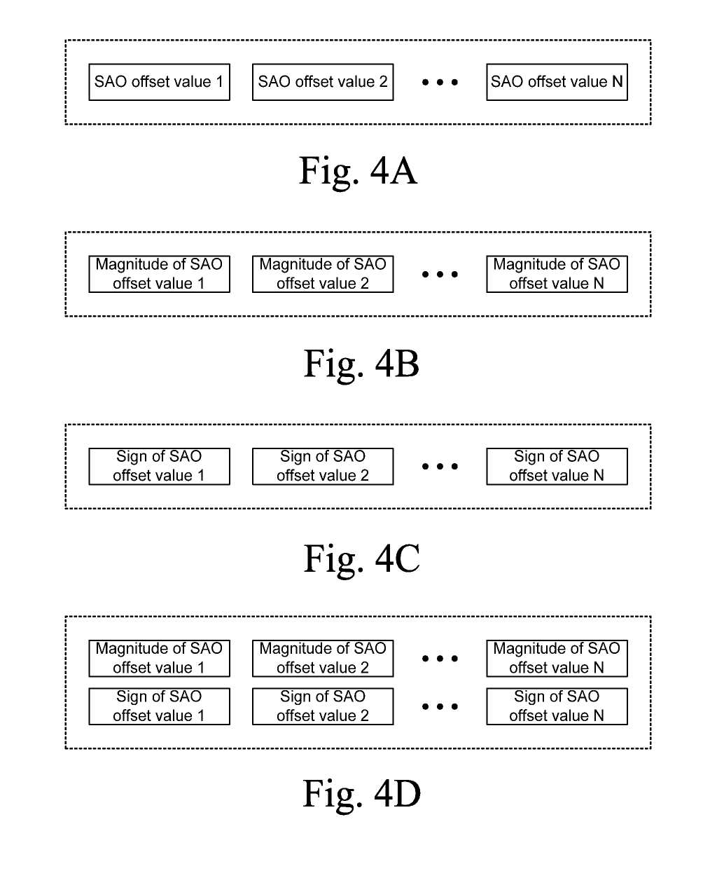

The SAO offset values (i.e., sao_offset) can be coded by context-adaptive binary arithmetic coding (CABAC) or variable length coding (VLC) to reduce the required data. In HM-6.0, four signed SAO offset values for the BO type or four unsigned SAO offset values for the EO type in each region are processed by entropy coding. The four signed SAO values are processed by entropy coding one by one as shown in FIG. 4A, where N (N=4 in HM-6.0) signed SAO values are to be entropy coded. However, after carefully studying the statistics of signed SAO values for regions in the BO type, it reveals that the negative offset probability is about the same as the positive offset probability. Therefore, the signs of the signed SAO offset values can be coded separately from the magnitude part using bypass mode or fixed-length code without noticeable impact on the coding efficiency.

The use of bypass mode coding or fixed length coding can reduce coding/decoding complexity. Accordingly, embodiments of the present invention apply bypass mode coding or fixed length coding to the sign part of the SAO offset values. On the other hand, the magnitude part of SAO offset values is still coded by entropy coding such as CABAC or VLC. Coding can be applied to the signed SAO offset values one by one. In other words, the sign part and the magnitude part of the first signed SAO offset value can be separately processed using respective bypass mode coding (or fixed length coding) and entropy coding. The processing then moves to the second signed SAO offset value and so on. FIG. 4D illustrates an example where each signed SAO offset value is separated into a magnitude part and a sign part. To further increase the parsing throughput, the signs of the SAO offset values associated with a region (LCU or CTB) can be extracted out and put into a group to avoid frequent switching between a bypass mode (for the signs) and the context adaptation mode (for the magnitudes) when CABAC is used to code the signed SAO offset values. For the group consists of signs extracted from the SAO offset values, they can be efficiently coded and also avoid frequent switching between bypass mode and regular decoding mode if CABAC is used. An embodiment according to the present invention separates the signs from magnitudes of the signed SAO offset values. FIG. 4B illustrates an example where the magnitudes of the signed SAO offset values are grouped together. FIG. 4C illustrates an example where the signs of the signed SAO offset values are grouped together. After the signs and magnitudes are separately grouped, respective coding techniques can be applied to the individual groups. Therefore, bypass coding is applied to the sign portion of the SAO offset values, and CABAC or VLC coding is applied to the magnitude portion of the SAO offset values.

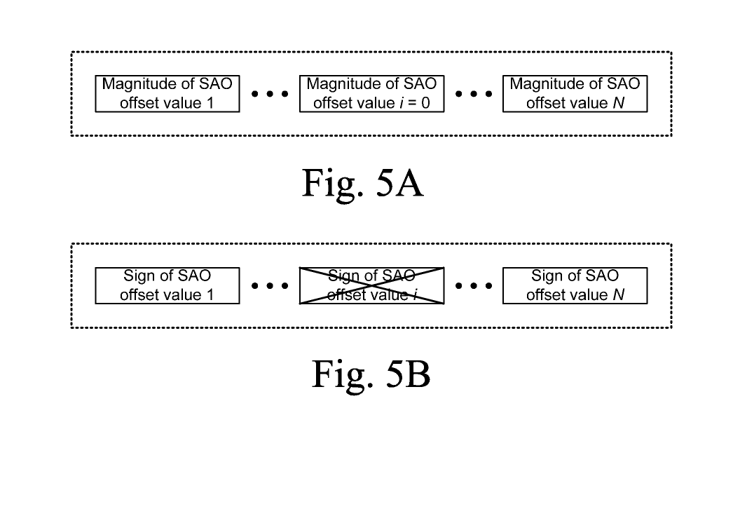

It is possible that sao_offset corresponds to zero. In this case, the sign is not needed if the magnitude is known to be zero. For example, if the magnitude is processed before the sign, the sign does not need to be transmitted if the corresponding magnitude is zero. Accordingly, another embodiment of the present invention checks whether an underlying signed value is zero. If the value is zero, no sign is transmitted for this value. After zero-value checking, the magnitudes and signs are grouped separately as shown in FIG. 5A and FIG. 5B respectively. In FIG. 5A, it illustrates an example where the magnitude for SAO offset value i is zero and the corresponding sign is not included in the sign group as shown in FIG. 5B.

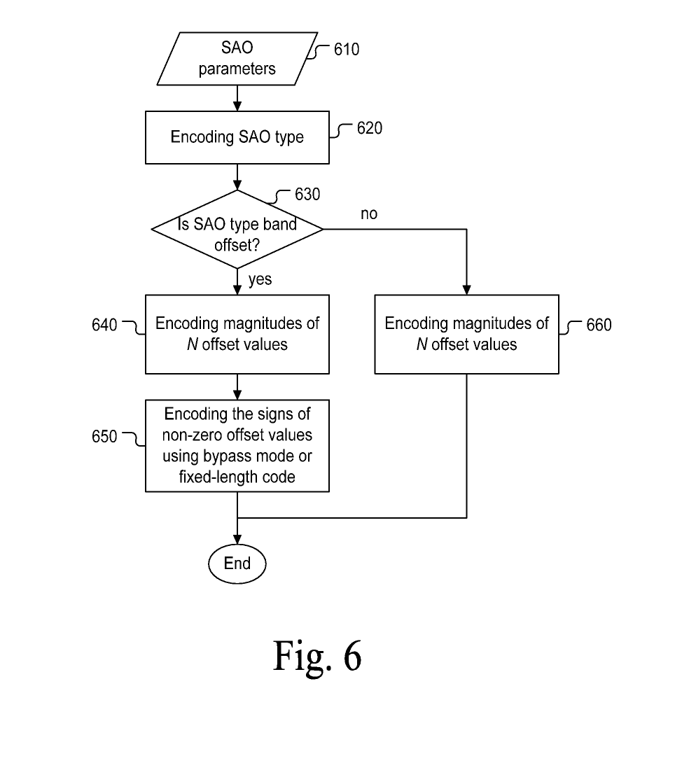

FIG. 6 illustrates an exemplary flowchart for an encoder incorporating an embodiment of the present invention for SAO parameter coding. The SAO type of the SAO parameters 610 is encoded in step 620. On the encoder side, the SAO parameters may be determined by a processor (such as a central processing unit, a microcontroller, or a digital signal processor). The SAO parameters may be received directly from a processor or retrieved from a media such as computer memory (DRAM, flash memory, etc.). In step 630, the SAO type is checked to determine whether it is band offset or not. If the type is band offset, the magnitudes of the N offset values of the region are encoded using entropy coding as shown in step 640 and the signs corresponding to the non-zero offset values of the region are encoded using bypass mode coding or fixed-length coding as shown in step 650. If the type is not band offset, it implies that edge offset is used and only the magnitudes of the N offset values of the region are encoded using entropy coding as shown in step 660. Since the signs of the N offset values are implicitly determined for the EO type, there is no need to transmit the signs.

Various entropy coding techniques can be applied to compress the magnitude part of the multiple SAO offset values. In one embodiment of the present invention, when variable length coding is applied to the magnitude part of the multiple SAO offset values, a portion of the codewords can be based on unary coding, truncated unary coding, or exponential-Golomb coding (exp-Golomb). For example, the magnitude part consists of 7 values (0 to 6) and the codewords for the 7 values are shown in Table 3.

TABLE 3

| Value | Codeword |
|---|---|
| 0 | 00 |
| 1 | 01 |
| 2 | 10 |
| 3 | 110 |
| 4 | 1110 |
| 5 | 11110 |
| 6 | 111110 |

The codewords in Table 3 have a prefix part represented by 2-bit fixed length code followed by a suffix part corresponding to unary coding. Similarly, when context adaptive binary arithmetic coding is applied to the magnitude part of the multiple SAO offset values, a portion of the codewords can be based on unary coding, truncated unary coding, or exponential-Golomb coding (exp-Golomb).

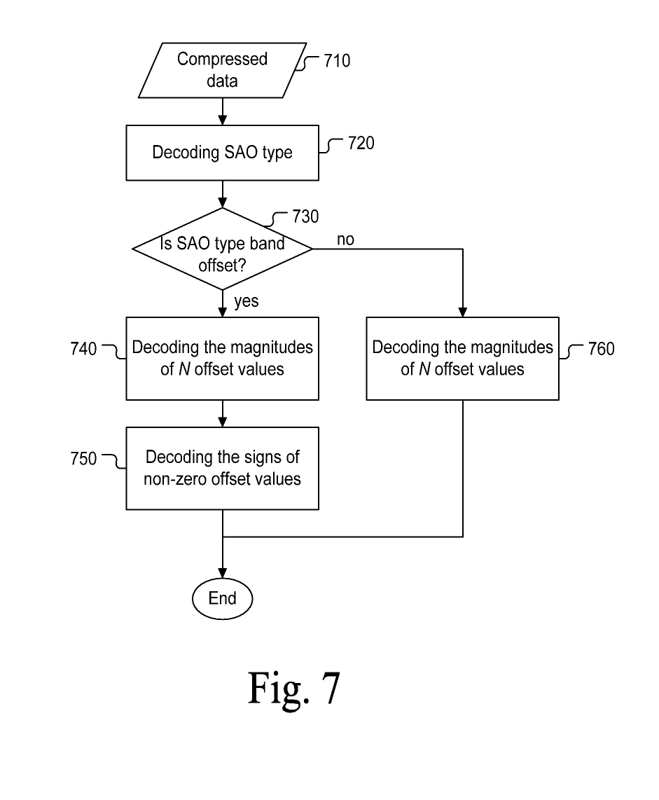

FIG. 7 illustrates an exemplary flowchart for a decoder incorporating an embodiment of the present invention for SAO parameter coding. In step 720, the SAO type is decoded from the compressed data 710. The compressed data may be stored in a media such as computer memory (DRAM, flash memory, etc.) or may be received from a processor in a previous stage (such as a receiver, a bitstream de-multiplexer, or other processor in a system). A syntax element corresponding to the SAO type has to be parsed from the compressed data before the SAO type can be decoded. In step 730, the SAO type is checked to determine whether it is band offset or not. If the type is band offset, the magnitudes of the N offset values of the region are decoded from the bitstream as shown in step 740 and the signs corresponding to the non-zero offset values of the region are decoded from the bitstream as shown in step 750. The syntax elements corresponding to the magnitudes of the N offset values have to be parsed from the compressed data before they can be decoded. Similarly, the syntax elements corresponding to the signs of the N SAO offset values need to be parsed before they can be decoded. Since the sign part is coded using bypass mode coding or fixed length coding, the parsing can be performed very efficiently. If the type is not band offset, it implies that edge offset is used and only the magnitudes of the N offset values of the region are decoded from the compressed data as shown in step 760. Since the signs of the N offset values are implicitly determined for the EO type, there are no signs for the EO offset values incorporated in the compressed data. The exemplary flowchart shown in FIG. 7 is for illustration purpose. A skilled person in the art may re-arrange, combine steps or split a step to practice the present invention without departing from the spirit of the present invention.

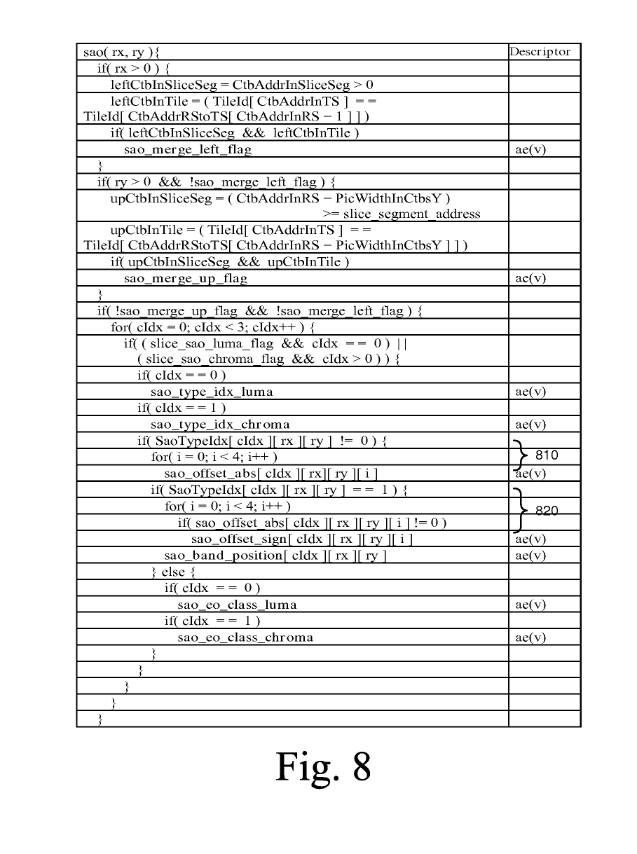

FIG. 8 illustrates an exemplary syntax design to support SAO parameter coding incorporating an embodiment of the present invention. In code section 810, magnitudes of four SAO offset values are incorporated if the SAO type is either band offset (BO) or edge offset (EO) (i.e., saoTypeIdx[cIdx][rx][ry] !=0). Furthermore, if the type is band offset (i.e., SaoTypeIdx[cIdx][rx][ry]==1), the signs of the SAO offset values are processed as shown in code section 820. The magnitude of the SAO offset is checked and if the magnitude is zero, there is no need to transmit the sign. Otherwise, the sign is incorporated in the bitstream. The syntax design in FIG. 8 is intended to illustrate an example to support SAO parameter coding according to an embodiment of the present invention. The example shall not be construed as limitations to the present invention. A person skilled in the art may use similar syntax design to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for decoding SAO (sample adaptive offset) parameters in a video decoder, the method comprising:
receiving compressed data associated with a region of a picture from a media or a processor;
decoding SAO type from the compressed data, wherein the SAO type comprises band offset;
decoding a sign part of multiple SAO offset values from the compressed data if the SAO type is the band offset, wherein the sign part is coded using bypass mode coding or fixed-length coding; and
decoding a magnitude part of the multiple SAO offset values if the SAO type is the band offset, wherein the magnitude part is coded using entropy coding.

2. The method of claim 1, the sign part of the multiple SAO offset values is omitted from the compressed data corresponding to the region of the picture if the SAO type is not the band offset.

3. The method of claim 1, further comprising checking magnitude of one multiple SAO offset value based on the magnitude part decoded when the SAO type is the band offset, wherein sign of said one multiple SAO offset value is omitted from the sign part of the multiple SAO offset values if the magnitude of said one multiple SAO offset value is zero.

4. The method of claim 1, wherein the sign part of the multiple SAO offset values corresponds to a first group associated with signs of the multiple SAO offset values, and the bypass mode coding or the fixed-length coding is applied to the first group.

5. The method of claim 1, wherein the magnitude part of the multiple SAO offset values corresponds to a second group associated with magnitudes of the multiple SAO offset values, and the entropy coding is applied to the second group.

6. The method of claim 1, wherein the entropy coding corresponds to context adaptive binary arithmetic coding or variable length coding.

7. The method of claim 6, wherein the magnitude part of the multiple SAO offset values is coded using variable length coding, and at least a portion of codewords for the magnitude part corresponds to unary coding, truncated unary coding, or exponential-Golomb coding.

8. The method of claim 6, wherein the magnitude part of the multiple SAO offset values is coded using context adaptive binary arithmetic coding, and at least a portion of codewords for the magnitude part corresponds to unary binarization, truncated unary binarization, or exponential-Golomb binarization.

9. The method of claim 1, wherein the SAO type further comprises edge offset and the multiple SAO offset values are unsigned values if the SAO type is the edge offset, and the method further comprises decoding the magnitude part of the multiple SAO offset values if the SAO type is the edge offset.

10. A method for coding SAO (sample adaptive offset) parameters in a video encoder, the method comprising:
receiving SAO parameters associated with a region of a picture from a media or a processor, wherein the SAO parameters comprise a SAO type and multiple SAO offset values, the SAO type comprises band offset, and the multiple SAO offset values are signed values if the SAO type is the band offset;
encoding the SAO type;
applying bypass mode coding or fixed-length coding to a sign part of the multiple SAO offset values if the SAO type is the band offset; and
applying entropy coding to a magnitude part of the multiple SAO offset values if the SAO type is the band offset.

11. The method of claim 10, the sign part of the multiple SAO offset values is omitted from compressed data corresponding to the region of the picture if the SAO type is not the band offset.

12. The method of claim 10, further comprising checking magnitude of one multiple SAO offset value when the SAO type is the band offset, wherein sign of said one multiple SAO offset value is omitted from the sign part of the multiple SAO offset values if the magnitude of said one multiple SAO offset value is zero.

13. The method of claim 10, wherein the sign part of the multiple SAO offset values corresponds to a first group associated with signs of the multiple SAO offset values, and the bypass mode coding or the fixed-length coding is applied to the first group.

14. The method of claim 10, wherein the magnitude part of the multiple SAO offset values corresponds to a second group associated with magnitudes of the multiple SAO offset values, and the entropy coding is applied to the second group.

15. The method of claim 10, wherein the entropy coding corresponds to context adaptive binary arithmetic coding or variable length coding.

16. The method of claim 15, wherein the magnitude part of the multiple SAO offset values is coded using variable length coding, and at least a portion of codewords for the magnitude part corresponds to using unary coding, truncated unary coding, or exponential-Golomb coding.

17. The method of claim 15, wherein the magnitude part of the multiple SAO offset values is coded using context adaptive binary arithmetic coding, and at least a portion of codewords for the magnitude part corresponds to unary binarization, truncated unary binarization, or exponential-Golomb binarization.

18. The method of claim 10, wherein the SAO type further comprises edge offset and the multiple SAO offset values are unsigned values if the SAO type is the edge offset, and the method further comprises applying the entropy coding to the magnitude part of the multiple SAO offset values if the SAO type is the edge offset.

19. An apparatus for decoding SAO (sample adaptive offset) parameters in a video decoder, the apparatus comprising:
means for receiving compressed data associated with a region of a picture from a media or a processor;
means for decoding SAO type from the compressed data, wherein the SAO type comprises band offset;
means for decoding a sign part of multiple SAO offset values from the compressed data if the SAO type is the band offset, wherein the sign part is coded using bypass mode coding or fixed-length coding; and
means for decoding a magnitude part of the multiple SAO offset values if the SAO type is the band offset, wherein the magnitude part is coded using entropy coding.

20. An apparatus for coding SAO (sample adaptive offset) parameters in a video encoder, the apparatus comprising:
means for receiving SAO parameters associated with a region of a picture from a media or a processor, wherein the SAO parameters comprise a SAO type and multiple SAO offset values, the SAO type comprises band offset, and the multiple SAO offset values are signed values if the SAO type is the band offset;
means for encoding the SAO type;
means for applying bypass mode coding or fixed-length coding to a sign part of the multiple SAO offset values if the SAO type is the band offset; and
means for applying entropy coding to a magnitude part of the multiple SAO offset values if the SAO type is the band offset.
